(19) United States
(12) Patent Application Publication
(10) Pub. No.: US 2026/0260821 A1
(43) Pub. Date: Sep. 3, 2026

(54) SOLID ELECTROLYTIC CAPACITOR ELEMENT, METHOD OF MANUFACTURING SAME, AND SOLID ELECTROLYTIC CAPACITOR

(71) Applicant: Panasonic Intellectual Property Management Co., Ltd., Osaka (JP)

(72) Inventors: TOMOYUKI TANIGUCHI, Osaka (JP); HIROAKI SUZUKI, Osaka (JP); KOHEI GOTO, Osaka (JP); HITOSHI ISHIMOTO, Hyogo (JP)

(21) Appl. No.: 19/163,189

(22) PCT Filed: Mar. 7, 2024
(86) PCT No.: PCT/JP2024/008868

§ 371 Date: Sep. 8, 2025

(30) Foreign Application Priority Data
Mar. 28, 2023 (JP) 2023-052085

(51) Int. Cl. H01G 9/15; H01G 9/00; H01G 9/025

(52) U.S. Cl. CPC H01G 9/15; H01G 9/0036; H01G 9/025

(57) ABSTRACT

A solid electrolytic capacitor element included in a solid electrolytic capacitor includes a conductor, a dielectric layer disposed on at least a part of a surface of the conductor, and a solid electrolyte layer covering at least a part of the dielectric layer. The solid electrolyte layer includes a first solid electrolyte covering at least the part of the dielectric layer, and a second solid electrolyte layer covering at least a part of the first solid electrolyte. The first solid electrolyte contains a self-doped conductive polymer. The second solid electrolyte layer includes at least a second solid electrolyte covering at least the part of the first solid electrolyte. The second solid electrolyte contains a non-self-doped conductive polymer. The solid electrolyte layer contains a silicon element disposed at an interface between the first solid electrolyte and the second solid electrolyte.

### TECHNICAL FIELD

The present disclosure relates to a solid electrolytic capacitor element, a method of manufacturing the same, and a solid electrolytic capacitor.

### BACKGROUND

The solid electrolytic capacitor includes, for example, a capacitor element and an exterior body that seals the capacitor element. The capacitor element includes, for example, a conductor (more specifically, an anode body), a dielectric layer disposed on a surface of the conductor, and a solid electrolyte layer covering at least a part of the dielectric layer. The solid electrolyte layer is formed by, for example, chemical polymerization, electrolytic polymerization, or the like, or is formed by using a treatment liquid (liquid dispersion or the like) containing a conductive polymer. As the conductive polymer, for example, a self-doped conductive polymer or a non-self-doped conductive polymer (such as a conjugated polymer and a dopant) is used.

PTL 1 relates to a polymer dispersion (slurry) formed of a conductive polymer and a polyanion, and proposes to use a copolymer having silane, phosphate, acrylate, or the like as the polyanion.

### CITATION LIST

### Patent Literature

PTL 1: Unexamined Japanese Patent Publication No. 2022-119742

### SUMMARY

A first aspect of the present disclosure relates to a solid electrolytic capacitor element. The solid electrolytic capacitor element includes a conductor, a dielectric layer disposed on at least a part of a surface of the conductor, and a solid electrolyte layer covering at least a part of the dielectric layer. The solid electrolyte layer includes a first solid electrolyte covering at least the part of the dielectric layer, and a second solid electrolyte layer covering at least a part of the first solid electrolyte. The first solid electrolyte contains a self-doped conductive polymer. The second solid electrolyte layer includes at least a second solid electrolyte covering at least the part of the first solid electrolyte. The second solid electrolyte contains a non-self-doped conductive polymer. The solid electrolyte layer contains a silicon element disposed at an interface between the first solid electrolyte and the second solid electrolyte.

A second aspect of the present disclosure relates to a solid electrolytic capacitor including: the solid electrolytic capacitor element; and an exterior body that seals the solid electrolytic capacitor element.

A third aspect of the present disclosure relates to a method for manufacturing a solid electrolytic capacitor element. The solid electrolytic capacitor element includes a conductor, a dielectric layer disposed on at least a part of a surface of the conductor, and a solid electrolyte layer covering at least a part of the dielectric layer. The manufacturing method includes a first step of preparing the conductor including the dielectric layer on the surface of the conductor, and a second step of forming the solid electrolyte layer to cover at least the part of the dielectric layer. The second step includes a first sub-step of forming a first solid electrolyte containing a self-doped conductive polymer to cover at least the part of the dielectric layer, a second sub-step of applying a first treatment liquid containing a silane compound to the first solid electrolyte and drying the treatment liquid, and a third sub-step of forming, after the second sub-step, a second solid electrolyte containing a non-self-doped conductive polymer to cover at least a part of the first solid electrolyte to which the silane compound is attached.

In the solid electrolytic capacitor, an initial high capacitance can be secured, and a decrease in capacitance when exposed to a high temperature can be suppressed.

### BRIEF DESCRIPTION OF THE DRAWINGS

FIG. 1 is a schematic sectional view illustrating a solid electrolytic capacitor according to an exemplary embodiment of the present disclosure.

### DESCRIPTION OF EMBODIMENT

From the viewpoint of securing an initial high capacitance, an initial withstand voltage, and the like, a solid electrolyte layer is required to have a certain thickness. In order to form a solid electrolyte layer having a certain thickness using a treatment liquid containing a conductive polymer, application and drying of the treatment liquid to a conductor having a dielectric layer are often repeated. However, when the application and drying of the treatment liquid are repeated, initial characteristics (such as initial capacitance) or capacitance when exposed to a high temperature may decrease.

When the application and drying of the treatment liquid containing the conductive polymer to the conductor having the dielectric layer are repeated, the initial characteristics (such as initial capacitance) or the capacitance when exposed to a high temperature may decrease. This is considered to be due to the following reason. When the application and drying of the treatment liquid are repeated, already formed coating of the conductive polymer is dissolved when the treatment liquid is applied. In particular, since a self-doped conductive polymer has an anionic group in its molecule, the molecule is flexible, and orientation is low, the self-doped conductive polymer is easily dissolved in a liquid medium in the treatment liquid. As a result, the coating of the conductive polymer is nonuniform, and a void is formed at an interface between coatings, or interface peeling occurs. In a state in which the coatings are partially in contact with each other, since a current concentrates on a contact portion, deterioration of the conductive polymer easily proceeds at this portion, and insulation proceeds. As a result, it is considered that resistance of the solid electrolyte layer increases, and the initial capacitance of the solid electrolytic capacitor decreases, or the capacitance decreases when the solid electrolytic capacitor is exposed to a high temperature.

In view of the above, (1) a solid electrolytic capacitor element according to a first aspect of the present disclosure includes a conductor, a dielectric layer disposed on at least a part of a surface of the conductor, and a solid electrolyte layer covering at least a part of the dielectric layer. The solid electrolyte layer includes a first solid electrolyte covering at least the part of the dielectric layer, and a second solid electrolyte layer covering at least a part of the first solid electrolyte. The first solid electrolyte contains a self-doped conductive polymer. The second solid electrolyte layer includes at least a second solid electrolyte covering at least the part of the first solid electrolyte. The second solid electrolyte contains a non-self-doped conductive polymer. The solid electrolyte layer contains a silicon element disposed at an interface between the first solid electrolyte and the second solid electrolyte (condition (a)).
(2) A solid electrolytic capacitor element according to a second aspect of the present disclosure includes a conductor, a dielectric layer disposed on at least a part of a surface of the conductor, and a solid electrolyte layer covering at least a part of the dielectric layer. The solid electrolyte layer includes a first solid electrolyte covering at least the part of the dielectric layer, and a second solid electrolyte layer covering at least a part of the first solid electrolyte. The first solid electrolyte contains a self-doped conductive polymer. The second solid electrolyte layer includes at least a second solid electrolyte covering at least the part of the first solid electrolyte. The second solid electrolyte contains a non-self-doped conductive polymer. The solid electrolyte layer includes a first region containing a silicon element disposed at and near an interface between the first solid electrolyte and the second solid electrolyte. A relationship of C_{R1}>C1 is satisfied, where C_{R1} represents a content ratio of the silicon element in the first region and C1 represents a content ratio of the silicon element in the first solid electrolyte (condition (b)).

The silicon element contained in the interface (hereinafter, may be referred to as a first interface) between the first solid electrolyte and the second solid electrolyte or the first region is derived from a silane compound. When at least one of the condition (a) and the condition (b) is satisfied, the silicon element (or the silane compound) may be unevenly distributed at the first interface or in the first region in the solid electrolyte layer. When at least one of the condition (a) and the condition (b) is satisfied, at least a part of a surface of the first solid electrolyte containing the self-doped conductive polymer is covered with the silane compound. Therefore, when the second solid electrolyte is formed using a treatment liquid containing a non-self-doped conductive polymer so as to cover the first solid electrolyte, dissolution of the self-doped conductive polymer from the first solid electrolyte is suppressed. Thus, nonuniformity of coating of the first solid electrolyte is reduced, and formation of the void at the interface between the first solid electrolyte and the second solid electrolyte and occurrence of the interface peeling are suppressed. Therefore, adhesion between the first solid electrolyte and the second solid electrolyte is improved. As a result, the initial high capacitance of the solid electrolytic capacitor is obtained. The formation of the void or the interface peeling occurs particularly significantly when the solid electrolytic capacitor is exposed to a high temperature. In the present disclosure, since the adhesion between the first solid electrolyte and the second solid electrolyte is improved, deterioration (or insulation) of these solid electrolytes due to local current concentration is suppressed. Therefore, it is possible to suppress a decrease in capacitance when the solid electrolytic capacitor is exposed to a high temperature. In addition, it is also possible to suppress the decrease in capacitance when the solid electrolytic capacitor is repeatedly charged and discharged. In addition, since the deterioration of the solid electrolyte when the solid electrolytic capacitor is exposed to a high temperature or repeatedly charged and discharged is suppressed, stress is less likely to be transmitted to the dielectric layer, and a more uniform solid electrolyte is maintained, and thus the local current concentration is suppressed, so that a leakage current can be reduced. Furthermore, presence of an insulating silane compound relatively uniformly at the first interface or in the first region makes it possible to increase the initial withstand voltage of the solid electrolytic capacitor and reduce the leakage current when the solid electrolytic capacitor is exposed to a high temperature and when the solid electrolytic capacitor is repeatedly charged and discharged. When the solid electrolytic capacitor is exposed to a high temperature or repeatedly charged and discharged, deterioration of characteristics (such as decrease in capacitance and increase in leakage current) is suppressed, so that high reliability can be obtained.

On the other hand, when the silane compound is contained in the treatment liquid containing the conductive polymer for forming the first solid electrolyte or the second solid electrolyte, the first solid electrolyte or the second solid electrolyte in which the silane compound is dispersed is formed. When the silane compound is dispersed in the first solid electrolyte, the initial capacitance decreases to a greater extent, and the capacitance when the solid electrolytic capacitor is exposed to a high temperature decreases. In particular, a capacitance reduction rate when charging and discharging are repeated and an increase in leakage current when the solid electrolytic capacitor is exposed to a high temperature are very remarkable. When the silane compound is dispersed in the second solid electrolyte, the decrease in capacitance when the solid electrolytic capacitor is exposed to a high temperature is remarkable, and the decrease in capacitance when the charging and discharging are repeated is also large. In addition, when the silane compound is unevenly distributed at and near the interface between the dielectric layer and the first solid electrolyte, the initial capacitance remarkably decreases, and the capacitance when the charging and discharging are repeated also significantly decreases. When the silane compound is present at and near an interface between solid electrolytes located outside the second solid electrolyte or in a surface layer of the second solid electrolyte layer, the decrease in capacitance when the solid electrolyte is exposed to a high temperature or repeatedly charged and discharged is significant. As described above, an effect of the present disclosure is an effect obtained only by satisfying at least one of the above conditions (a) and (b), and cannot be obtained in other aspects even when the silane compound is contained in the solid electrolyte layer. That is, in order to obtain the above effect, it is preferable that the silane compound is unevenly distributed at the first interface between the first solid electrolyte and the second solid electrolyte or in the first region, and the content ratio (C_{R1}) of the silicon element at the first interface between the first solid electrolyte and the second solid electrolyte or in the first region is the highest from the dielectric layer to the surface layer of the second solid electrolyte layer. In other words, it is preferable that the content ratio (C_{R1}) of the silicon element at the first interface between the first solid electrolyte and the second solid electrolyte or in the first region is higher than any of the content ratio of the silicon element at the interface between the dielectric layer and the first solid electrolyte, the content ratio (C1) of the silicon element in the first solid electrolyte, the content ratio of the silicon element in the second solid electrolyte, and the content ratio of the silicon element in the surface layer of the second solid electrolyte layer.

Note that in the solid electrolytic capacitor or the solid electrolytic capacitor element, the silane compound contained in the solid electrolyte layer is a component derived from the silane compound contained in the treatment liquid used when the silane compound is applied to the solid electrolyte layer. The silane compound contained in the solid electrolyte layer may be the same as the silane compound contained in the treatment liquid, or may be modified or decomposed (hydrolyzed or the like).
(3) In the configuration of the above (1) or (2), the non-self-doped conductive polymer may contain a conjugated polymer and a dopant. The second solid electrolyte containing such a conductive polymer is formed using, for example, a treatment liquid containing the conjugated polymer and the dopant. When such a treatment liquid is used, the self-doped conductive polymer is easily dissolved, but even in such a case, by satisfying at least one of the above conditions (a) and (b), the initial high capacitance of the solid electrolytic capacitor can be secured, and the high reliability can be secured.
(4) In the configuration of any one of the above (1) to (3), the silicon element may be derived from a hydrolysis reaction product of a silane coupling agent. In other words, the silane compound present at the first interface or in the first region may be the hydrolysis reaction product of the silane coupling agent. In this case, the silane compound is easily available, and the silicon element (or the silane compound) can be easily unevenly distributed at the first interface or in the first region.
(5) In the configuration of any one of the above (1) to (4), the self-doped conductive polymer may have a skeleton of a conjugated polymer and an anionic group introduced into the skeleton. The skeleton of the conjugated polymer may include a repeating structure of a monomer unit corresponding to a polythiophene compound. Such a self-doped conductive polymer easily obtains relatively high heat resistance, and can further suppress the deterioration of the characteristics when the solid electrolytic capacitor is exposed to a high temperature.
(6) In the configuration of the above (5), the skeleton of the conjugated polymer may include a repeating structure of a monomer unit corresponding to 3,4-ethylenedioxythiophene. The self-doped conductive polymer having such a skeleton easily obtains relatively high heat resistance, and can further suppress the deterioration of the characteristics when the solid electrolytic capacitor is exposed to a high temperature.
(7) The present disclosure also includes a solid electrolytic capacitor including the solid electrolytic capacitor element having a configuration of any one of the above (1) to (6) and an exterior body that seals the solid electrolytic capacitor element.
(8) The present disclosure also includes a method for manufacturing a solid electrolytic capacitor element including a conductor, a dielectric layer disposed on at least a part of a surface of the conductor, and a solid electrolyte layer covering at least a part of the dielectric layer. The manufacturing method includes a first step of preparing the conductor including the dielectric layer on the surface, and a second step of forming the solid electrolyte layer to cover at least the part of the dielectric layer. The second step includes: a first sub-step of forming a first solid electrolyte containing a self-doped conductive polymer to cover at least the part of the dielectric layer; a second sub-step of applying a treatment liquid (second treatment liquid) containing a silane compound to the first solid electrolyte and drying the treatment liquid; and a third sub-step of forming, after the second sub-step, a second solid electrolyte containing a non-self-doped conductive polymer to cover at least a part of the first solid electrolyte to which the silane compound is attached. By the first sub-step to the third sub-step, the silicon element (or the silane compound) can be distributed to at least one of the first interface and the first region, and the initial high capacitance and the high reliability of the solid electrolytic capacitor can be secured.
(9) In the configuration of the above (8), the silane compound may contain a silane coupling agent. In this case, the silane compound is easily available, and the silicon element (or the silane compound) can be easily unevenly distributed at the first interface or in the first region.
(10) In the configuration of the above (8) or (9), a concentration of the silane compound in the treatment liquid (second treatment liquid) may be 3 mass % or more and 10 mass % or less. In this case, the silicon element (or the silane compound) can be easily unevenly distributed at the first interface or in the first region. It is easy to secure higher reliability of the solid electrolytic capacitor by suppressing the decrease in initial capacitance.
(11) In the configuration of any one of the above (8) to (10), in the first sub-step, the first solid electrolyte may be formed using a treatment liquid (first treatment liquid) containing the self-doped conductive polymer.
(12) In the configuration of any one of the above (8) to (11), in the third sub-step, the second solid electrolyte may be formed using a liquid dispersion containing the non-self-doped conductive polymer.

Hereinafter, the solid electrolytic capacitor element, the method for manufacturing the same, and the solid electrolytic capacitor of the present disclosure will be described in more detail, including the configurations of the above (1) to (12). To the extent that there is no technical contradiction, at least one of the configurations of the above (1) to (12) and at least one of elements described below may be combined. The solid electrolytic capacitor element may be simply referred to as a capacitor element.

### [Solid Electrolytic Capacitor]

The capacitor element included in the solid electrolytic capacitor includes an anode part and a cathode part. In the solid electrolytic capacitor and the capacitor element of the present disclosure, constituent elements other than the solid electrolyte layer constituting the cathode part are not particularly limited, and constituent elements used in known solid electrolytic capacitors may be applied.

### (Capacitor Element)

The capacitor element includes the conductor, the dielectric layer disposed on at least a part of the surface of the conductor, and the cathode part covering at least a part of the dielectric layer. The conductor corresponds to an anode body and constitutes the anode part.

### (Anode Part)

The anode part includes the conductor as the anode body. The anode part may include the conductor and a wire (also referred to as an anode wire).

### (Conductor (Anode Body))

The conductor may include a valve metal, an alloy containing the valve metal, a compound containing the valve metal, or the like. The conductor may contain one kind of these materials, or may contain two or more kinds of these materials in combination. As the valve metal, for example, aluminum, tantalum, niobium, and titanium are preferable.

The conductor preferably includes a porous part at least in the surface layer. The conductor includes a large number of fine voids in the porous part. With such a porous part, the conductor has a fine uneven shape.

The conductor including the porous part on the surface layer is obtained, for example, by roughening a surface of a substrate (sheet-like (for example, foil-like or plate-like) substrate, or the like) containing the valve metal. The roughening may be performed by, for example, etching (electrolytic etching, chemical etching, or the like). Such a conductor has, for example, a core and a porous part formed integrally with the core on both surfaces of the core.

The conductor may be a porous molded body or a porous sintered body of particles containing the valve metal (a sintered body of a porous molded body, or the like). Each of the molded body and the sintered body may have a sheet shape, a rectangular parallelepiped, a cube, or a shape similar thereto. The porous sintered body may be, for example, a porous sintered body containing tantalum.

The conductor may usually have an electrode lead-out part (also referred to as an anode lead-out part) including a first end and a cathode formation part including a second end opposite to the first end. The cathode part including the solid electrolyte layer is formed on a surface of the cathode formation part of the anode body. The anode lead-out part is used, for example, for electrical connection with an external electrode on the anode side. An anode lead terminal may be connected to the anode lead-out part.

### (Anode Wire)

When the conductor is the porous sintered body or the porous molded body, the anode part may include the anode wire. The anode wire may be a wire made of metal. Examples of a material of the anode wire include the above-described valve metal, copper, or a copper alloy. A part of the anode wire is embedded in the conductor, and a remaining part protrudes outward from an end surface of the conductor. An end of the anode wire protruding outward corresponds to the first end, and an end of the conductor on a side opposite to the first end corresponds to the second end.

### (Dielectric Layer)

The dielectric layer is formed, for example, so as to cover at least a part of the surface (for example, at least a part of a surface of the porous part) of the conductor. The dielectric layer is an insulating layer that functions as a dielectric. The dielectric layer can be formed by a known method. The dielectric layer is formed, for example, by oxidizing the valve metal on the surface of the conductor by an anodizing treatment or the like. For example, the dielectric layer may be formed by immersing the conductor in an anodizing solution and applying a voltage. When the dielectric layer is formed on the surface of the porous part of the conductor, a surface of the dielectric layer has a fine uneven shape along a shape of the porous part.

The dielectric layer contains an oxide of the valve metal. For example, when tantalum is used as the valve metal, the dielectric layer contains tantalum oxide such as Ta₂O₅, and when aluminum is used as the valve metal, the dielectric layer contains aluminum oxide such as Al₂O₃. Note that the dielectric layer is not limited to these examples, and only needs to function as the dielectric.

### (Cathode Part)

The cathode part includes at least a solid electrolyte layer covering at least a part of the dielectric layer. The solid electrolyte layer is formed in a portion on the second end side of the conductor (in other words, the cathode formation part) with the dielectric layer interposed therebetween. The cathode part usually includes a solid electrolyte layer covering at least a part of the dielectric layer, and a cathode lead-out layer covering at least a part of the solid electrolyte layer. Hereinafter, the solid electrolyte layer and the cathode lead-out layer will be described.

### (Solid Electrolyte Layer)

In the capacitor element, the solid electrolyte layer is formed to cover at least a part of the dielectric layer. The solid electrolyte layer includes a first solid electrolyte containing a silicon element (or a silane compound) and covering at least a part of the dielectric layer, and a second solid electrolyte layer covering at least a part of the first solid electrolyte. Here, the first solid electrolyte contains the self-doped conductive polymer. The second solid electrolyte layer includes at least a second solid electrolyte covering at least a part of the first solid electrolyte. The second solid electrolyte contains a non-self-doped conductive polymer. Note that in the following description, the second solid electrolyte may be referred to as a solid electrolyte 2A.

The second solid electrolyte layer may contain one or two or more solid electrolytes outside the solid electrolyte 2A in addition to the solid electrolyte 2A. For example, the second solid electrolyte layer may include the solid electrolyte 2A and a solid electrolyte 2B covering at least a part of the solid electrolyte 2A. Further, the second solid electrolyte layer may include a solid electrolyte 2C covering at least a part of the solid electrolyte 2B in addition to the solid electrolyte 2A and the solid electrolyte 2B.

In the present disclosure, the solid electrolyte layer satisfies at least one of the following conditions (a) and (b). Thus, excellent initial characteristics (high capacitance, leakage current suppression effect, and the like) can be obtained, and the high reliability of the solid electrolytic capacitor can be secured.
(a) The solid electrolyte layer contains a silicon element (or a silane compound) disposed at the interface (first interface) between the first solid electrolyte and the solid electrolyte 2A.
(b) The solid electrolyte layer includes the first region containing a silicon element (or a silane compound) disposed at and near the interface between the first solid electrolyte and the solid electrolyte 2A, and the relationship of C_{R1}>C1 is satisfied, where C_{R1} represents the content ratio of the silicon element in the first region and C1 represents the content ratio of the silicon element in the first solid electrolyte.

In the condition (a), it is preferable that the silicon element (or the silane compound) is present at least between the first solid electrolyte and the solid electrolyte 2A, and is unevenly distributed between the first solid electrolyte and the solid electrolyte 2A. The silicon element (or the silane compound) may be present in a continuous or discontinuous layer at the first interface. In addition, the silicon element (or the silane compound) may be unevenly distributed at the first interface and near the first interface (at least one of a part of the first solid electrolyte on the first interface side and a part of the solid electrolyte 2A on the first interface side). Note that the region containing the silicon element (or the silane compound) at and near the first interface corresponds to the first region in the condition (b).

In the condition (b), the solid electrolyte layer satisfies the relationship of C_{R1}>C1. In other words, when focusing on the first solid electrolyte and the first region, the silicon element (or the silane compound) is unevenly distributed in the first region. In this case, when a content ratio of the silicon element in the solid electrolyte 2A is C2A, a relationship of C_{R1}>C2A may be further satisfied. In other words, the silicon element (or the silane compound) may be unevenly distributed in the first region.

From the viewpoint of easily obtaining more excellent initial characteristics and reliability, in any of the conditions (a) and (b), the content ratio Cri of the silicon element in the first region is preferably higher than the content ratio of the silicon element in the other part of the solid electrolyte layer. From the same viewpoint, a part of the solid electrolyte layer outside the solid electrolyte 2A may contain no silicon element (or silane compound) or may contain the silicon element at a content ratio lower than C_{R1}. Cases where the part of the solid electrolyte layer outside the solid electrolyte 2A does not contain the silicon element (or the silane compound) also include a case where the silicon element (or the silane compound) in the part of the solid electrolyte layer outside the solid electrolyte 2A is equal to or less than a detection limit.

A ratio C1/C_{R1} of the content ratio C1 to the content ratio C_{R1} is less than 1, and may be 0.5 or less or 0.1 or less. The first solid electrolyte may not contain the silicon element (that is, C1/C_{R1}=0 may be satisfied). When the ratio C1/C_{R1} is in such a range, it is easy to obtain a solid electrolytic capacitor excellent in a balance between excellent initial characteristics and high reliability.

A ratio C2A/C_{R1} of a content ratio C2A to the content ratio C_{R1} is less than 1, and may be 0.5 or less or 0.1 or less. The solid electrolyte 2A may not contain the silicon element (that is, C2A/C_{R1}=0 may be satisfied). When the ratio C2A/C_{R1} is in such a range, it is easy to obtain the solid electrolytic capacitor excellent in the balance between excellent initial characteristics and high reliability. Further, when a content ratio of the silicon element in the second solid electrolyte layer is C2, the ratio C2A/C_{R1} of the content ratio C2 to the content ratio C_{R1} may be the same as a range described for the ratio C2A/C_{R1}.

Distinction between the solid electrolytes constituting the solid electrolyte layer and distribution state of the silicon element (or the silane compound) can be analyzed by, for example, electron probe micro analyzer (EPMA) analysis of a sectional image. For example, the EPMA analysis is performed at equal intervals in the sectional image of the entire solid electrolyte layer, and an interface between adjacent solid electrolytes and the distribution state of the silicon element (or the silane compound) can be determined from a difference in wavelength of characteristic X-ray at measurement points. The content ratios of the silicon element in the solid electrolytes, the interface, or the first region can be determined by the EPMA analysis using samples collected from a section of a sample (more specifically, samples collected from a plurality of locations (for example, five locations) in the section of the sample).

The above samples are prepared by embedding the solid electrolytic capacitor or the capacitor element in an acrylic resin, cutting the capacitor element in a direction parallel to a length direction at a center of the capacitor element in a width direction to expose and polish the section. A direction from the first end toward the second end in a state where the conductor (or the anode body) is flat may be referred to as a length direction of the conductor (or the anode body). The direction from the first end toward the second end is a direction parallel to a linear direction connecting a center of an end surface of the first end and a center of an end surface of the second end. This direction may be referred to as a length direction of the anode body or the capacitor element. Further, a direction perpendicular to the length direction and a thickness direction of the anode body (or the capacitor element) may be referred to as a width direction of the conductor (or the anode body) or the capacitor element.

### (Silane Compound)

The silane compound present at the first interface or in the first region is detected as the silicon element in the EPMA analysis. The silicon element (or the silane compound) present at the first interface or in the first region may be derived from the silane coupling agent. The solid electrolyte layer may contain a hydrolyzate of the silane coupling agent at the first interface or in the first region. The silane coupling agent is easily available, easily bonded to the solid electrolyte, and easily distributed at the first interface or in the first region. When the silane coupling agent is used, it is easy to form a very thin insulating layer containing the silicon element (or the silane compound), and thus it is easy to secure high withstand voltage while keeping the leakage current low.

As the silane coupling agent, a silane coupling agent having an epoxy group, a silane coupling agent having an acrylic group, and the like are preferable because they are advantageous for increasing the capacitance. Examples of the silane coupling agent having the epoxy group include 2-(3,4-epoxycyclohexyl)ethyltrimethoxysilane, 3-glycidoxypropyltrimethoxysilane, 3-glycidoxypropylmethyldiethoxysilane, and 3-glycidoxypropyltriethoxysilane. Examples of the silane coupling agent having the acrylic group include 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane (Y-acryloxypropyltrimethoxysilane). Examples of other silane coupling agents include vinyltrichlorosilane, vinyltrimethoxysilane, vinyltriethoxysilane, p-styryltrimethoxysilane, N-2-(aminoethyl)-3-aminopropylmethyldimethoxysilane, N-2-(aminoethyl)-3-aminopropyltriethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene) propylamine, N-phenyl-3-aminopropyltrimethoxysilane, N-(vinylbenzyl)-2-aminoethyl-3-aminopropyltrimethoxysilane hydrochloride, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl) tetrasulfide, and 3-isocyanatopropyltriethoxysilane. They may be used alone or in combination of two or more kinds thereof.

### (Conductive Polymer)

The solid electrolyte layer contains the conductive polymer. The conductive polymer may be the self-doped conductive polymer, the non-self-doped conductive polymer, or a combination thereof as necessary. The first solid electrolyte contains the self-doped conductive polymer, and the solid electrolyte 2A contains the non-self-doped conductive polymer. A portion other than the solid electrolyte 2A of the second solid electrolyte layer may contain the non-self-doped conductive polymer from the viewpoint of easily securing a certain thickness and obtaining a high capacitance. The non-self-doped conductive polymer includes, for example, the conjugated polymer and the dopant.

Viscosity of the treatment liquid containing the self-doped conductive polymer is relatively low. Therefore, when the first solid electrolyte contains the self-doped conductive polymer, the treatment liquid also penetrates into the fine voids of the conductor having the dielectric layer, and coating of the self-doped conductive polymer is easily formed also on inner walls of the voids.

A ratio of the non-self-doped conductive polymer to the solid electrolyte 2A (a total ratio of the conjugated polymer and the dopant) may be, for example, 75 mass % or more, or 90 mass % or more. A ratio of the non-self-doped conductive polymer to the conductive polymer contained in the solid electrolyte 2A is 100 mass % or less. The conductive polymer contained in the solid electrolyte 2A may be composed of only the non-self-doped conductive polymer. A ratio of the non-self-doped conductive polymer to each solid electrolyte other than the solid electrolyte 2A constituting the second solid electrolyte layer may be set within a range described for the solid electrolyte 2A, and the conductive polymer contained in each solid electrolyte may be composed of only the non-self-doped conductive polymer.

The self-doped conductive polymer has, for example, the skeleton of the conjugated polymer and a functional group (such as an anionic group) that functions as a dopant directly or indirectly bonded to the skeleton by a covalent bond.

Examples of the anionic group include a sulfo group, a carboxy group, a phosphate group, and a phosphonic acid group. The self-doped conductive polymer may contain one kind or two or more kinds of anionic groups. From the viewpoint of easily securing higher conductivity of the self-doped conductive polymer, the self-doped conductive polymer may contain at least a sulfo group.

In the solid electrolyte layer, the anionic group of the self-doped conductive polymer may be contained in any form of anion, free, ester, salt, or the like, or may be contained in a form of interaction with or complexed with a component contained in the solid electrolyte layer. In the present specification, all of these forms are simply referred to as anionic groups.

Examples of the conjugated polymer constituting the skeleton of the self-doped conductive polymer include a polymer having a π-conjugated polymer (polypyrrole, polythiophene, polyaniline, polyfuran, polyacetylene, polyphenylene, polyphenylene vinylene, polyacene, polythiophene vinylene, and the like) as a basic skeleton. The above-mentioned polymers only need to contain at least one type of monomer unit constituting the basic skeleton. The above-mentioned polymers also include a homopolymer, a copolymer of two or more kinds of monomers, and derivatives of these polymers (such as a substituted derivative having a substituent group). For example, polythiophene includes poly(3,4-ethylenedioxythiophene) and the like. The self-doped conductive polymer has an anionic group in the skeleton of these conjugated polymers. The anionic group may be directly introduced into the skeleton of the conjugated polymer, or may be introduced via a linking group. The linking group is preferably, for example, a polyvalent group (divalent group) including an alkylene group. Examples of the linking group include an aliphatic polyvalent group (divalent group and the like) such as an alkylene group, and a —R¹—X—R²— group (X is an oxygen element or a sulfur element, and R¹ and R² are the same or different and each is an alkylene group). The number of carbon atoms of each alkylene group included in the linking group is, for example, 1 or more and 10 or less, and may be 1 or more and 6 or less. The alkylene group may be linear or branched. The linking group may include, for example, at least an alkylene group having 2 or more carbon atoms. The number of carbon atoms in such an alkylene group may be 2 or more (or 3 or more) and 10 or less, or may be 2 or more (or 3 or more) and 6 or less. For example, R¹ may be an alkylene group having 1 or more and 6 or less carbon atoms, and R² may be an alkylene group having 2 or more (or 3 or more) and 10 or less carbon atoms. However, the linking group is not limited thereto.

The conjugated polymer constituting the skeleton of the self-doped conductive polymer may be polypyrrole, polythiophene, or polyaniline. From the viewpoint of easily obtaining high conductivity and the like, the self-doped conductive polymer is preferably a polymer having a skeleton of a conjugated polymer containing a repeating structure of a monomer unit corresponding to a thiophene compound and an anionic group introduced into the skeleton.

Examples of the thiophene compound include a compound having a thiophene ring and capable of forming a repeating structure of corresponding monomer units. The thiophene compound can be linked at the 2- and 5-positions of the thiophene ring to form the repeating structure of a monomer unit.

The thiophene compound may have, for example, a substituent at least one of the 3- and 4-positions of the thiophene ring. The substituent at the 3-position and the substituent at the 4-position may be linked to form a ring fused to a thiophene ring. Examples of the thiophene compound include thiophene which may have a substituent at least one of the 3- and 4-positions and an alkylene dioxythiophene compound (C₂₋₄ alkylenedioxythiophene compound such as an ethylenedioxythiophene compound, and the like). The alkylene dioxythiophene compound also includes a compound having a substituent in an alkylene group moiety.

The substituent is preferably an alkyl group (for example, a C₁₋₄ alkyl group such as a methyl group and an ethyl group), an alkoxy group (for example, a C₁₋₄ alkoxy group such as a methoxy group and an ethoxy group), a hydroxy group, or a hydroxyalkyl group (for example, a hydroxy C₁₋₄ alkyl group such as a hydroxymethyl group), and the like, but is not limited thereto. When the thiophene compound has two or more substituents, the substituents may be the same or different from each other. The thiophene ring (at least one of the thiophene ring and the alkylene group, in the alkylene dioxythiophene ring) may have the above-described anionic group or a group including an anionic group (for example, a sulfoalkyl group or the like) as the substituent.

The self-doped conductive polymer may have a skeleton of a conjugated polymer (such as PEDOT) containing at least a repeating structure of a monomer unit corresponding to a 3,4-ethylenedioxythiophene compound (such as 3,4-ethylenedioxythiophene (EDOT)). The skeleton of the conjugated polymer containing at least a repeating structure of a monomer unit corresponding to EDOT may contain only a monomer unit corresponding to EDOT, or may contain a monomer unit corresponding to a thiophene compound other than EDOT in addition to the monomer unit.

A weight average molecular weight (Mw) of the self-doped conductive polymer may be 1,000 or more and 1 million or less, or 1,000 or more and 50,000 or less.

Note that in the present specification, the weight average molecular weight (Mw) is a value in terms of polystyrene measured by gel permeation chromatography (GPC). The GPC is usually measured using a polystyrene gel column, and water and methanol (volume ratio: 8/2) as a mobile phase.

The non-self-doped conductive polymer includes, for example, the conjugated polymer (non-self-doped conjugated polymer (for example, a conjugated polymer having no anionic group) or the like) and the dopant.

Examples of the conjugated polymer include conjugated polymers (π-conjugated polymers and the like) exemplified as conjugated polymers constituting the skeleton of the self-doped conductive polymer. The conjugated polymer may be used alone or in combination of two or more kinds thereof. From the viewpoint of easily securing the initial high capacitance, the initial withstand voltage, the high heat resistance, and the like, a non-self-doped conjugated polymer containing a repeating structure of a monomer unit of the thiophene compound may be used. Examples of the thiophene compound corresponding to the monomer unit of the non-self-doped conjugated polymer include the thiophene compound described for the self-doped conductive polymer. The non-self-doped conjugated polymer may contain a conjugated polymer (such as PEDOT) containing at least a repeating structure of a monomer unit corresponding to a 3,4-ethylenedioxythiophene compound (such as EDOT). The conjugated polymer containing at least a repeating structure of a monomer unit corresponding to EDOT may contain only the monomer unit corresponding to EDOT, or may contain the monomer unit corresponding to the thiophene compound other than EDOT in addition to the monomer unit.

Examples of the dopant include at least one selected from the group consisting of an anion and a polyanion (such as a polymer anion). Examples of the anion include a sulfate ion, a nitrate ion, a phosphate ion, a borate ion, an organic sulfonate ion, and a carboxylate ion. Examples of the dopant that generates sulfonate ions include p-toluenesulfonic acid and naphthalenesulfonic acid. From the viewpoint of easily obtaining higher heat resistance and reliability and higher withstand voltage, the polymer anion may be used. Examples of a polymer anion having a sulfo group include a polymer type polysulfonic acid. Specific examples of the polymer anion include polyvinylsulfonic acid, polystyrenesulfonic acid (PSS (also including a copolymer, a substituted derivative having a substituent group, and the like)), polyallylsulfonic acid, polyacrylsulfonic acid, polymethacrylsulfonic acid, poly(2-acrylamide-2-methylpropanesulfonic acid), polyisoprenesulfonic acid, polyestersulfonic acid (such as aromatic polyester sulfonic acid), and phenolsulfonic acid novolac resin. However, the dopant is not limited to these specific examples. The dopant may be used alone or in combination of two or more kinds thereof.

In the non-self-doped conductive polymer (for example, the solid electrolyte 2A and the second solid electrolyte layer), an amount of the dopant may be 10 parts by mass or more and 1000 parts by mass or less, or 20 parts by mass or more and 500 parts by mass or less with respect to 100 parts by mass of the conjugated polymer.

In the solid electrolyte layer, an aggregating agent (cationic component, cationic component and anionic component, or the like) may be interposed between the adjacent solid electrolytes (for example, between the first solid electrolyte and the solid electrolyte 2A, and between the solid electrolyte 2A and the solid electrolyte 2B).

The solid electrolyte layer or each solid electrolyte may contain an additive as necessary. The solid electrolyte layer or each solid electrolyte may contain a known conductive material other than the conductive polymer as necessary. Examples of the conductive material include at least one kind selected from the group consisting of conductive inorganic materials of manganese compounds (such as manganese dioxide), and TCNQ complex salts.

The adjacent solid electrolytes may have different compositions or the same composition. Cases of “having different compositions” include a case where components (at least one selected from the group consisting of the conjugated polymer, the dopant, and the additive, and the like) contained in each solid electrolyte are different, a case where content ratios of the components contained in each solid electrolyte are different, and the like.

### (Formation of Solid Electrolyte Layer)

The solid electrolyte layer is formed through the step (second step) of forming the solid electrolyte layer so as to cover at least a part of the dielectric layer. The step (second step) of forming the solid electrolyte layer is performed after the step (first step) of preparing the conductor having the dielectric layer on the surface. In the first step, the dielectric layer can be formed by the known method as described for the dielectric layer.

### (Second Step)

The second step includes, for example, the first sub-step of forming the first solid electrolyte, the second sub-step of applying the silane compound to the first solid electrolyte, and the third sub-step of forming the solid electrolyte 2A after the second sub-step. When the solid electrolyte layer further includes the solid electrolytes 2B, 2C, and the like outside the solid electrolyte 2A, the second step further includes a sub-step of forming these solid electrolytes.

Each solid electrolyte formed in each sub-step may be a continuous or discontinuous layer. From the viewpoint of securing a certain degree of initial characteristics and high reliability, the second solid electrolyte layer including the solid electrolyte 2A and the like is layered as a whole.

### (First Sub-Step)

In the first sub-step, a first solid electrolyte layer containing the self-doped conductive polymer is formed to cover at least a part of the dielectric layer. For example, the first solid electrolyte may be formed using the treatment liquid (first treatment liquid) containing the self-doped conductive polymer. More specifically, in the first sub-step, the first treatment liquid containing the self-doped conductive polymer is applied to the dielectric layer to form the first solid electrolyte. The first treatment liquid may be applied to the dielectric layer and then dried. In the first sub-step, the application and drying of the first treatment liquid to the dielectric layer may be repeated twice or more as necessary. The self-doped conductive polymer used in the first sub-step corresponds to the self-doped conductive polymer described for the solid electrolyte layer.

The first treatment liquid contains, for example, the self-doped conductive polymer and the liquid medium. The first treatment liquid may contain one kind or two or more kinds of self-doped conductive polymers. The liquid medium is, for example, a medium that is liquid at room temperature (for example, 20° C. or higher and 35° C. or lower). Examples of the liquid medium include water, an organic solvent, and a mixture thereof.

The first treatment liquid may be a liquid dispersion in which particles of the self-doped conductive polymer are dispersed in the liquid medium, or may be a solution in which the self-doped conductive polymer is dissolved in the liquid medium. In the self-doped conductive polymer, polymer chains are relatively flexible, positions of functional groups such as anionic groups are random, and in addition, polymer chains have low orientation and low crystallinity. Therefore, as compared with the non-self-doped conductive polymer, the self-doped conductive polymer is easily dissolved in the liquid medium or dispersed in a fine particle form. Therefore, viscosity of the first treatment liquid is relatively low, and the first treatment liquid can be easily impregnated with high permeability into the voids of the conductor.

A concentration of the self-doped conductive polymer in the first treatment liquid may be 0.5 mass % or more and 5 mass % or less, or may be 1 mass % or more and 3 mass % or less.

The first treatment liquid may contain the silane compound (silane compound (for example, the silane coupling agent) exemplified for the solid electrolyte layer, and the like), but from the viewpoint of securing higher initial capacitance and higher reliability, it is preferable that the first treatment liquid does not contain the silane compound. When the first treatment liquid contains the silane compound, the concentration of the silane compound in the first treatment liquid is preferably lower than the concentration of the silane compound in the second treatment liquid. From the viewpoint of securing higher initial capacitance and higher reliability, the concentration of the silane compound in the first treatment liquid may be 5 mass % or less, less than 3 mass %, 1 mass % or less, or 0.1 mass % or less. Cases where the first treatment liquid does not contain the silane compound include a case where the concentration of the silane compound in the first treatment liquid is equal to or less than a detection limit.

### (Second Sub-Step)

In the second sub-step, the treatment liquid (second treatment liquid) containing the silane compound is applied to the first solid electrolyte and dried. In the second sub-step, the application and drying of the second treatment liquid to the anode body may be repeated twice or more as necessary.

The second treatment liquid may contain the silane compound and the liquid medium. The second treatment liquid may contain one kind of silane compound, or may contain two or more kinds thereof in combination. As the silane compound, description of the silane compound for the solid electrolyte layer can be referred to. The silane compound preferably contains, for example, the silane coupling agent.

For the liquid medium, description of the first treatment liquid can be referred to. Examples of the liquid medium include water, an organic solvent, and a mixture thereof.

The concentration of the silane compound in the second treatment liquid may be 1 mass % or more. The concentration of the silane compound in the second treatment liquid may be 3 mass % or more. When the concentration of the silane compound is in such a range, it is easy to allow the silicon element (or the silane compound (including a component derived from the silane compound such as a hydrolyzate)) to be present at a certain content ratio at the first interface or in the first region, and it is easy to secure more excellent initial characteristics and higher reliability of the solid electrolytic capacitor. From the viewpoint of easily securing initial higher capacitance, the concentration of the silane compound in the second treatment liquid may be 15 mass % or less, 10 mass % or less, or 5 mass % or less. The concentration of the silane compound in the second treatment liquid may be, for example, 1 mass % or more and 15 mass % or less, 1 mass % or more and 10 mass % or less, 3 mass % or more and 10 mass % or less, or 1 mass % or more and 5 mass % or less.

It is preferable that the second treatment liquid does not contain a conductive polymer (for example, neither the self-doped conductive polymer nor the non-self-doped conductive polymer is contained). Even when the second treatment liquid contains the conductive polymer, a concentration of the conductive polymer is preferably low, and may be, for example, 1 mass % or less or 0.1 mass % or less. Cases where the second treatment liquid does not contain the conductive polymer include a case where the concentration of the conductive polymer in the second treatment liquid is equal to or less than a detection limit.

### (Third Sub-Step)

The third sub-step is performed after the second sub-step. Thus, the silicon element (or the silane compound (including the component derived from the silane compound such as the hydrolyzate)) can be distributed (preferably unevenly distributed) at the first interface or in the first region.

In the third sub-step, the solid electrolyte 2A containing the non-self-doped conductive polymer (hereinafter, may be referred to as non-self-doped conductive polymer 2A) is formed so as to cover at least a part of the first solid electrolyte to which the silane compound is attached. For example, the solid electrolyte 2A is formed using a liquid dispersion (hereinafter, may be referred to as a liquid dispersion 2A) containing the non-self-doped conductive polymer 2A. The solid electrolyte 2A is formed to cover at least a part of the first solid electrolyte. The silicon element (or the silane compound (including the component derived from the silane compound such as the hydrolyzate)) is at least partially present at the first interface between the first solid electrolyte and the solid electrolyte 2A. The silicon element (or the silane compound) may be distributed in a continuous or discontinuous layer between the first solid electrolyte and the solid electrolyte 2A. The silicon element (or the silane compound) may be distributed in at least one of a part of the first solid electrolyte on the solid electrolyte 2A side and a part of the solid electrolyte 2A on the first solid electrolyte side in addition to between the first solid electrolyte and the solid electrolyte 2A.

The non-self-doped conductive polymer 2A may contain the conjugated polymer and the dopant corresponding to the self-doped conductive polymer described for the solid electrolyte layer. The liquid dispersion 2A may contain one kind of non-self-doped conductive polymer 2A, or may contain two or more kinds thereof in combination. More specifically, the liquid dispersion 2A may contain one kind of conjugated polymer, or may contain two or more kinds thereof in combination. The liquid dispersion 2A may contain one kind of dopant, or may contain two or more kinds thereof in combination.

The liquid dispersion 2A usually contains the liquid medium in addition to the non-self-doped conductive polymer 2A. For the liquid medium, description of the first treatment liquid can be referred to. Examples of the liquid medium include water, an organic solvent, and a mixture thereof.

In the third sub-step, the liquid dispersion 2A may be applied to the first solid electrolyte to which the silane compound is attached, and then dried. The application and drying of the liquid dispersion 2A may be repeated twice or more as necessary. In addition, the aggregating agent may be applied and dried after drying as necessary. For example, the application and drying of the liquid dispersion 2A, and the application and drying of the aggregating agent may be repeated.

The concentration of the conductive polymer in the liquid dispersion 2A (more specifically, total concentration of the conjugated polymer and the dopant) may be 0.5 mass % or more and 5 mass % or less, or may be 1 mass % or more and 3 mass % or less.

The liquid dispersion 2A may contain the silane compound (silane compound (for example, the silane coupling agent) exemplified for the solid electrolyte layer, and the like), but from the viewpoint of securing more excellent initial characteristics and higher reliability, it is preferable that the liquid dispersion 2A does not contain the silane compound. When the liquid dispersion 2A contains the silane compound, the concentration of the silane compound in the liquid dispersion 2A is preferably lower than the concentration of the silane compound in the second treatment liquid. From the viewpoint of securing more excellent initial characteristics and higher reliability, the concentration of the silane compound in the liquid dispersion 2A may be 5 mass % or less, less than 3 mass %, 1 mass % or less, or 0.1 mass % or less. Cases where the liquid dispersion 2A does not contain the silane compound include a case where the concentration of the silane compound in the liquid dispersion 2A is equal to or less than a detection limit.

### Others

The second step may include, as necessary, a sub-step of forming the solid electrolyte 2B covering the solid electrolyte 2A, and may further include a sub-step of forming the solid electrolyte 2C covering the solid electrolyte 2B, and the like. The solid electrolyte 2B or the solid electrolyte 2C may be formed by in situ polymerization (chemical polymerization, electrolytic polymerization, or the like) using a treatment liquid containing a precursor of the conductive polymer (a precursor of the conjugated polymer, the dopant, or the like). From the viewpoint of forming the second solid electrolyte layer having a certain thickness, the solid electrolyte 2B or the solid electrolyte 2C may be formed using the treatment liquid (the liquid dispersion or the solution) containing the conductive polymer, in accordance with the case of the solid electrolyte 2A. It is preferable that the treatment liquid containing the conductive polymer or the precursor thereof does not contain the silane compound, or the concentration of the silane compound in the treatment liquid is lower than the concentration in the second treatment liquid, as in the case of the liquid dispersion 2A. The concentration of the silane compound in the treatment liquid may be selected from a range described for the liquid dispersion 2A. Examples of the precursor of the conjugated polymer include monomers, oligomers, and prepolymers.

The second step preferably does not include a sub-step of applying the treatment liquid containing the silane compound after the solid electrolyte 2A is formed. Even in this case, it is easy to secure more excellent initial characteristics and higher reliability. Note that it is preferable that a step of applying the treatment liquid containing the silane compound is not included even after the second step.

The capacitor element of the present disclosure is manufactured by a manufacturing method including the first step and the second step.

### (Cathode Lead-Out Layer)

The cathode lead-out layer may include, for example, at least a first layer that is in contact with the solid electrolyte layer and covers at least a part of the solid electrolyte layer. The cathode lead-out layer may include the first layer and a second layer covering at least a part of the first layer.

Examples of the first layer include a layer containing conductive particles, and a metal foil. Examples of the conductive particles include at least one kind selected from conductive carbon and metal powder. The cathode part (more specifically, the cathode lead-out layer) may include a layer containing the metal powder (such as a metal particle-containing layer). The cathode lead-out layer may include, for example, a layer containing the conductive carbon (a carbon layer) as the first layer, and the layer containing the metal powder (such as the metal particle-containing layer) or the metal foil as the second layer.

When the cathode lead-out layer includes the metal foil or the metal particle-containing layer, the entire cathode lead-out layer may include the metal foil or the metal particle-containing layer. Further, at least one of the first layer and the second layer may include the metal particle-containing layer.

Examples of the conductive carbon include graphite (artificial graphite, natural graphite, and the like).

The layer containing the metal powder as the second layer can be formed, for example, by laminating a composition containing the metal powder on a surface of the first layer. Examples of such a second layer include the metal particle-containing layer formed using a paste containing the metal powder and a resin binder. As the resin binder, a thermoplastic resin can be used, but it is preferable to use a thermosetting resin such as an imide-based resin or an epoxy resin. From the viewpoint of easily obtaining high conductivity of the second layer, silver-containing particles may be used as the metal powder. Examples of the silver-containing particles include silver particles and silver-alloy particles. The second layer may contain one kind of silver-containing particles, or may contain two or more kinds thereof in combination. The silver particles may contain a small amount of impurities.

When the metal foil is used as the first layer, the type of metal is not particularly limited. It is preferable to use the valve metal (aluminum, tantalum, niobium, or the like) or the alloy containing the valve metal, for the metal foil. If necessary, a surface of the metal foil may be roughened. The surface of the metal foil may be provided with an anodization coating film, or may be provided with a coating of a metal (dissimilar metal) different from a metal constituting the metal foil or a nonmetal. Examples of the dissimilar metal and the nonmetal include metals such as titanium and nonmetals such as carbon (conductive carbon or the like).

The coating of the dissimilar metal or the nonmetal (for example, the conductive carbon) may be the first layer, and the metal foil may be the second layer.

The cathode lead-out layer is formed by a known method according to the layer configuration. For example, when the cathode lead-out layer includes the metal foil as the first layer or the second layer, the first layer or the second layer is formed by laminating the metal foil so as to cover at least a part of the solid electrolyte layer or the first layer. The first layer containing the conductive particles is formed, for example, by applying a conductive paste or a liquid dispersion containing the conductive particles and, if necessary, the resin binder (water-soluble resin, curable resin, or the like) to a surface of the solid electrolyte layer. The second layer containing the metal powder is formed, for example, by applying the paste containing the metal powder and the resin binder to the surface of the first layer. In a process of forming the cathode lead-out layer, a drying treatment, a heat treatment, or the like may be performed as necessary.

### Others

The solid electrolytic capacitor includes at least one capacitor element. The solid electrolytic capacitor may be a wound type, or may be either a chip type or a laminated type. For example, the solid electrolytic capacitor may include a plurality of laminated capacitor elements. Further, the solid electrolytic capacitor may include two or more wound type capacitor elements. The configuration of the capacitor element may be selected according to the type of the solid electrolytic capacitor.

When the metal foil is used for the cathode lead-out layer, a separator may be disposed between the metal foil and the anode foil as the anode body. The separator is not particularly limited, and for example, a nonwoven fabric containing a fiber of cellulose, polyethylene terephthalate, vinylon, and polyamide (for example, aliphatic polyamide and aromatic polyamide such as aramid) may be used.

In the capacitor element, one end of a cathode lead terminal may be electrically connected to the cathode lead-out layer. For example, a conductive adhesive is applied to the cathode lead-out layer, and the cathode lead terminal is bonded to the cathode lead-out layer with the conductive adhesive interposed therebetween. One end of the anode lead terminal may be electrically connected to the anode lead-out part of the anode body. The other end of the anode lead terminal and the other end of the cathode lead terminal are respectively drawn out from a resin exterior body or a case. The other end of each terminal exposed from the resin exterior body or the case is used for solder connection or the like with a substrate on which the solid electrolytic capacitor is to be mounted. Further, the present disclosure is not limited to a case where the lead terminal is drawn out, and an end surface of at least one of the anode part and the cathode part may be exposed from an outer surface of a sealing body and electrically connected to the external electrode.

The capacitor element is sealed using the resin exterior body or the case. For example, the capacitor element and a material resin (for example, uncured thermosetting resin and filler) of the exterior body may be placed in a mold, and the capacitor element may be sealed with the resin exterior body by a transfer molding method, a compression molding method, or the like. At this time, the other end side portions of the anode lead terminal and the cathode lead terminal, the anode lead terminal being connected to an anode lead drawn out from the capacitor element, are exposed from the mold. Further, the capacitor element may be housed in a bottomed case such that the other end side portions of the anode lead terminal and the cathode lead terminal are positioned on an opening side of the bottomed case, and the opening of the bottomed case may be sealed with the sealing body to form the solid electrolytic capacitor. The lead may have a wire shape or a frame shape (such as a lead frame).

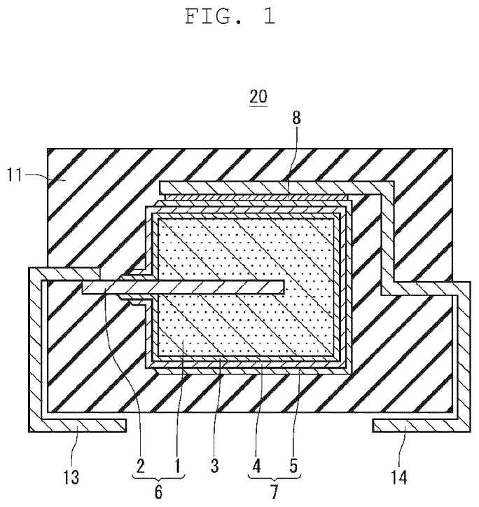

FIG. 1 is a schematic sectional view illustrating the solid electrolytic capacitor according to an exemplary embodiment of the present disclosure.

A solid electrolytic capacitor 20 includes a capacitor element 10 including an anode part 6 and a cathode part 7, an exterior body 11 for sealing the capacitor element 10, an anode lead frame 13 electrically connected to the anode part 6, and a cathode lead frame 14 electrically connected to the cathode part 7.

The anode part 6 includes an anode body 1 and an anode wire 2. A part of the anode wire 2 is embedded in the anode body 1, and a remaining part protrudes outward from an outer surface of the anode body 1. A part of a first portion of the anode lead frame 13 is joined and electrically connected to a protruding portion of the anode wire 2 by welding or the like.

A dielectric layer 3 is formed on a surface of the anode body 1. The cathode part 7 includes a solid electrolyte layer 4 covering at least a part of the dielectric layer 3, and a cathode lead-out layer 5 covering at least a part of the surface of the solid electrolyte layer 4. The cathode lead-out layer 5 includes a carbon layer formed to cover at least a part of the surface of the solid electrolyte layer 4, and a metal particle-containing layer formed to cover at least a part of the carbon layer. Then, a part of a first portion of the cathode lead frame 14 is bonded and electrically connected to the cathode lead-out layer 5 with a conductive adhesive layer 8 interposed therebetween.

### EXAMPLES

Hereinafter, the present invention will be specifically described with reference to Examples and Comparative Examples, but the present invention is not limited to the following Examples.

### Example 1

The capacitor element was prepared in the following manner, and its characteristics were evaluated.

### (1) Preparation of Conductor (Anode Body) Having Dielectric Layer (First Step)

As the anode body, a tantalum sintered body (porous body) in which a part of the anode wire was embedded was prepared. A surface of the tantalum sintered body was anodized to form the dielectric layer containing tantalum oxide on the surface of the anode body.

### (2) Formation of Solid Electrolyte Layer (Second Step)

### (2-1) First Sub-Step

An aqueous dispersion (A first treatment liquid) containing a self-doped polythiophene-based polymer was prepared. A concentration of the polythiophene-based polymer in the first treatment liquid was set to 1 to 3 mass %. As the self-doped polythiophene-based polymer, PEDOT (Mw: about 10,000) having a sulfo group bonded to a PEDOT skeleton with a linking group including a butylene group therebetween was used.

The tantalum sintered body prepared in the above (1) was immersed in the first treatment liquid for about 30 to 60 seconds, and then the tantalum sintered body was pulled up from the dispersion. Next, the tantalum sintered body pulled up from the dispersion was heated (dried) at 140° C. to 180° C. for 10 to 20 minutes to form the first solid electrolyte.

### (2-2) Second Sub-Step

The tantalum sintered body in which the first solid electrolyte was formed was immersed in an aqueous solution (the second treatment liquid) containing 3-glycidoxypropyltrimethoxysilane (silane compound) at a concentration of 3 to 10 mass % under a reduced pressure for about 10 to 20 minutes, returned to atmospheric pressure, and then further immersed for about 5 to 10 minutes, and the tantalum sintered body was pulled up from the second treatment liquid. Next, the tantalum sintered body pulled up from the second treatment liquid was heated at 100° C. to 150° C. for 10 to 30 minutes to perform the drying treatment.

### (2-3) Third Sub-Step

The solid electrolyte 2A was formed using the liquid dispersion 2A. Specifically, first, the tantalum sintered body to which the silane compound obtained in (2-2) was attached was immersed in the liquid dispersion 2A for about 30 to 60 seconds, and then the tantalum sintered body was pulled up from the liquid dispersion 2A. Next, the tantalum sintered body pulled up from the liquid dispersion 2A was heated (dried) at 140° C. to 180° C. for 10 to 20 minutes to form the solid electrolyte 2A. As the liquid dispersion 2A, an aqueous dispersion containing a non-self-doped conductive polymer (PEDOT doped with PSS) at a concentration of 1 to 3 mass % was used.

Furthermore, immersion of the tantalum sintered body in the liquid dispersion 2A and the drying were repeated a plurality of times to form the second solid electrolyte layer. In this way, an anode body having a solid electrolyte layer was formed. The solid electrolyte layer thus obtained contains a silicon element derived from the silane compound at the first interface or in the first region.

### (3) Formation of Cathode Lead-Out Layer

The tantalum sintered body, in which the solid electrolyte layer was formed, obtained in the above (2) was immersed in a dispersion liquid in which graphite particles were dispersed in water, taken out from the dispersion liquid, and then dried to form the carbon layer (first layer) on the surface of the solid electrolyte layer. The drying was performed at 180° C. for 10 to 30 minutes.

Then, a silver paste containing silver particles and a binder resin (an epoxy resin) was applied onto a surface of the carbon layer, dried at 60° C. to 80° C. for 20 to 40 minutes, and then further heated at 180° C. for 30 to 60 minutes to cure the binder resin, to form the metal particle-containing layer (second layer). In this way, a cathode lead-out layer including the carbon layer and the metal particle-containing layer was formed.

In this way, a total of 30 capacitor elements E1 including a cathode part including the solid electrolyte layer and the cathode lead-out layer were prepared.

### Comparative Example 1

A capacitor element R1 was prepared in the same manner as in Example 1 except that the second sub-step was not performed.

### Comparative Example 2

The same operation as in the second sub-step was performed after the first step and before the second step, and the second sub-step was not performed. A capacitor element R2 was prepared in the same manner as in Example 1 except for these. The capacitor element R2 thus obtained contains the silicon element derived from the silane compound at and near the interface between the dielectric layer and the first solid electrolyte.

### Comparative Example 3

The second sub-step was performed after the third sub-step. A capacitor element R3 was prepared in the same manner as in Example 1 except for this. In the capacitor element R3 thus obtained, the solid electrolyte layer contains the silicon element derived from the silane compound in the surface layer of the second solid electrolyte layer including the solid electrolyte 2A.

### Comparative Example 4

An aqueous dispersion (A first treatment liquid) containing the self-doped polythiophene-based polymer and 3-glycidoxypropyltrimethoxysilane (silane compound) was prepared. In the first treatment liquid, the concentration of the polythiophene-based polymer was set to 1 to 3 mass %, and the concentration of the silane compound was set to 3 to 10 mass %. In addition, the second sub-step was not performed. A capacitor element R4 was prepared in the same manner as in Example 1 except for these. In the capacitor element R4 thus obtained, the silane compound is dispersed in the first solid electrolyte.

### Comparative Example 5

As the liquid dispersion 2A, an aqueous dispersion containing the non-self-doped conductive polymer (PEDOT doped with PSS) and 3-glycidoxypropyltrimethoxysilane (silane compound) was used. In the liquid dispersion 2A, the concentration of the non-self-doped conductive polymer was set to 1 to 3 mass %, and the concentration of the silane compound was set to 3 to 10 mass %. In addition, the second sub-step was not performed. A capacitor element R5 was prepared in the same manner as in Example 1 except for these. In the capacitor element R5 thus obtained, the silane compound is dispersed in the second solid electrolyte layer including the solid electrolyte 2A.

### Evaluation

The capacitor elements obtained in Example 1 and Comparative Examples 1 to 5 were used to perform the following evaluations.

### (1) Initial Characteristics (Electrostatic Capacitance (Cap))

Under an environment of 20° C., initial electrostatic capacitance C0 (μF) of the capacitor element at a frequency of 120 Hz was measured using an LCR meter for 4-terminal measurement. Then, an average value of 30 capacitor elements was obtained.

### (2) Initial Characteristics (Leakage Current (LC))

A resistor of 1 kΩ is connected in series to the 30 capacitor elements whose electrostatic capacitances C0 have been measured, and a rated voltage (for example, 35 V) is applied for 1 minute by a DC power supply. The leakage current (initial leakage current) (μA) after application of this voltage was measured, and an average value of 30 capacitor elements was obtained.

### (3) Initial Characteristics (Withstand Voltage)

Out of the capacitor elements of which the leakage current was measured, a voltage was applied to 10 capacitor elements while increasing the voltage at a rate of 2.5 V/sec, and a breakdown voltage (V) at which an overcurrent of 0.5 A flowed was measured. Then, an average value of 10 capacitor elements was obtained.

### (4) Capacitance Reduction Rate (ΔCap) and Leakage Current (LC) Under High Temperature Load

Electrostatic capacitance (Cx) after the rated voltage (for example, 35 V) was applied at 125° C. for 24 hours was measured for 10 capacitor elements among remaining 20 capacitor elements for which the initial characteristic (3) was not measured, in the same procedure as the initial electrostatic capacitance C0. Then, the capacitance reduction rate (ΔCap) due to high temperature load was obtained from the following formula.

$$Δ Cap ( \% ) = ( C 0 - Cx ) / C 0 \times 100$$

The leakage current (μA) after applying the rated voltage (for example, 35 V) at 125° C. for 24 hours to 10 capacitor elements of which the electrostatic capacitance Cx was measured, was measured in accordance with a case of the initial leakage current, and an average value of 10 capacitor elements was obtained.

### (5) Capacitance Reduction Rate (ΔCap) and Leakage Current (LC) During Charging and Discharging

Remaining 10 capacitor elements not used in measurement of the above (4) were charged to the rated voltage (for example, 35 V) at 25° C. and discharged to 0 V. This charge and discharge cycle was repeated 800 cycles. Electrostatic capacitance Cy (Discharge capacitance) at 800 cycles was measured in the same procedure as the initial electrostatic capacitance. Then, the capacitance reduction rate (ΔCap) due to charging and discharging was obtained from the following formula.

$$Δ Cap ( \% ) = ( C 0 - Cy ) / C 0 \times 100$$

10 capacitor elements of which the electrostatic capacitance Cy was measured were charged to the rated voltage (for example, 35 V) at 25° C., held for 30 seconds, discharged to 0 V, and held for 30 seconds. This cycle of charge (including holding at the rated voltage for 30 seconds) and discharge (including holding at 0 V for 30 seconds) was repeated for 800 cycles. The leakage current (μA) after 800 cycles was measured in accordance with the case of the initial leakage current, and an average value of 10 capacitor elements was obtained.

Evaluation results are shown in Table 1. In Table 1, the capacitor element E1 is Example 1, and the capacitor elements R1 to R5 are Comparative Examples 1 to 5. Each evaluation result is shown by a relative value when a result of the capacitor element R1 is 100.

TABLE 1

| | | Initial characteristics | | | Reliability (relative value) | | | |
|---|---|---|---|---|---|---|---|---|
| | | (relative value) | | | After charging | | Under high | |
| | Distribution position of | | Withstand | | and discharging | | temperature load | |
| | silane compound | Cap | voltage | LC | ΔCap | LC | ΔCap | LC |
| E1 | At first interface or | 98.5 | 110 | 33.3 | 104 | 47.4 | 89.4 | 25.4 |
| | in first region | | | | | | | |
| R1 | — | 100 | 100 | 100 | 100 | 100 | 100 | 100 |
| R2 | At and near interface | 74.9 | 113 | 27.8 | 129 | 63.2 | 16.1 | 4.76 |
| | between dielectric layer | | | | | | | |
| | and first solid electrolyte | | | | | | | |
| R3 | Surface layer of second | 99.5 | 101 | 19.4 | 140 | 78.9 | 277 | 143 |
| | solid electrolyte | | | | | | | |
| R4 | Dispersed in first | 95.3 | 96.5 | 30.5 | 182 | 57.9 | 114 | 217 |
| | solid electrolyte | | | | | | | |
| R5 | Dispersed in second | 98.5 | 102 | 22.2 | 138 | 52.6 | 388 | 110 |
| | solid electrolyte | | | | | | | |

As shown in Table 1, when the silane compound (or the silicon element derived from the silane compound) is distributed at the first interface or in the first region, the initial high capacitance is obtained and a decrease in capacitance when the capacitor element is exposed to a high temperature is reduced as compared with when the silane compound is not used, when the silane compound is distributed at another interface, and when the silane compound is dispersed in the first solid electrolyte or the second solid electrolyte layer. In addition, in Example, the leakage current when the capacitor element is exposed to a high temperature is suppressed to be low, and capacitance change and the leakage current when the charging and discharging are repeated are also suppressed to be low. In Example, the initial withstand voltage is high and the leakage current is kept low.

### INDUSTRIAL APPLICABILITY

In the solid electrolytic capacitor and the capacitor element of the present disclosure, the initial high capacitance can be secured, and the decrease in capacitance when exposed to a high temperature can be suppressed. In addition, it is possible to suppress the decrease in capacitance when the solid electrolytic capacitor is repeatedly charged and discharged. Therefore, it is suitable for applications in which high capacitance and high reliability are required. However, the application of the solid electrolytic capacitor is not limited thereto.

### REFERENCE MARKS IN THE DRAWINGS

20: solid electrolytic capacitor
10: capacitor element
1: anode body
2: anode wire
3: dielectric layer
4: solid electrolyte layer
5: cathode lead-out layer
6: anode part
7: cathode part
8: conductive adhesive layer
11: exterior body
13: anode lead frame
14: cathode lead frame

1. A solid electrolytic capacitor element comprising:
a conductor;
a dielectric layer disposed on at least a part of a surface of the conductor; and
a solid electrolyte layer covering at least a part of the dielectric layer, wherein:
the solid electrolyte layer includes a first solid electrolyte covering at least the part of the dielectric layer, and a second solid electrolyte layer covering at least a part of the first solid electrolyte,
the first solid electrolyte contains a self-doped conductive polymer,
the second solid electrolyte layer includes a second solid electrolyte covering at least the part of the first solid electrolyte,
the second solid electrolyte contains a non-self-doped conductive polymer, and
the solid electrolyte layer contains a silicon element disposed at an interface between the first solid electrolyte and the second solid electrolyte.

2. A solid electrolytic capacitor element comprising:
a conductor;
a dielectric layer disposed on at least a part of a surface of the conductor; and
a solid electrolyte layer covering at least a part of the dielectric layer, wherein:
the solid electrolyte layer includes a first solid electrolyte covering at least the part of the dielectric layer, and a second solid electrolyte layer covering at least a part of the first solid electrolyte,
the first solid electrolyte contains a self-doped conductive polymer,
the second solid electrolyte layer includes a second solid electrolyte covering at least the part of the first solid electrolyte,
the second solid electrolyte contains a non-self-doped conductive polymer,
the solid electrolyte layer includes a first region containing a silicon element disposed at and near an interface between the first solid electrolyte and the second solid electrolyte, and
a relationship of C_{R1}>C1 is satisfied, where C_{R1} represents a content ratio of the silicon element in the first region and C1 represents a content ratio of the silicon element in the first solid electrolyte.

3. The solid electrolytic capacitor element according to claim 1, wherein the non-self-doped conductive polymer contains a conjugated polymer and a dopant.

4. The solid electrolytic capacitor element according to claim 1, wherein the silicon element is derived from a hydrolysis reaction product of a silane coupling agent.

5. The solid electrolytic capacitor element according to claim 1, wherein:
the self-doped conductive polymer has a skeleton of a conjugated polymer and an anionic group introduced into the skeleton, and
the skeleton includes a repeating structure of a monomer unit corresponding to a polythiophene compound.

6. The solid electrolytic capacitor element according to claim 5,
wherein the skeleton includes a repeating structure of a monomer unit corresponding to 3,4-ethylenedioxythiophene.

7. A solid electrolytic capacitor comprising:
the solid electrolytic capacitor element according to claim 1; and
an exterior body that seals the solid electrolytic capacitor element.

8. A method for manufacturing a solid electrolytic capacitor element including a conductor, a dielectric layer disposed on at least a part of a surface of the conductor; and a solid electrolyte layer covering at least a part of the dielectric layer, the method comprising:
a first step of preparing the conductor including the dielectric layer on the surface of the conductor; and
a second step of forming the solid electrolyte layer to cover at least the part of the dielectric layer, wherein:
the second step includes:
a first sub-step of forming a first solid electrolyte containing a self-doped conductive polymer to cover at least the part of the dielectric layer;
a second sub-step of applying a treatment liquid containing a silane compound to the first solid electrolyte and drying the treatment liquid; and
a third sub-step of forming, after the second sub-step, a second solid electrolyte containing a non-self-doped conductive polymer to cover at least a part of the first solid electrolyte to which the silane compound is attached.

9. The method for manufacturing the solid electrolytic capacitor element according to claim 8, wherein the silane compound contains a silane coupling agent.

10. The method for manufacturing the solid electrolytic capacitor element according to claim 8, wherein a concentration of the silane compound in the treatment liquid is 3 mass % or more and 10 mass % or less.

11. The method for manufacturing the solid electrolytic capacitor element according to claim 8, wherein in the first sub-step, the first solid electrolyte is formed using a first treatment liquid containing the self-doped conductive polymer.

12. The method for manufacturing the solid electrolytic capacitor element according to claim 8, wherein in the third sub-step, the second solid electrolyte is formed using a liquid dispersion containing the non-self-doped conductive polymer.
